(19) United States
(12) Patent Application Publication
(10) Pub. No.: US 2014/0306886 A1
(43) Pub. Date: Oct. 16, 2014

(54) IMAGE PROCESSING DEVICE, METHOD FOR CONTROLLING IMAGE PROCESSING DEVICE, PROGRAM, AND INFORMATION RECORDING MEDIUM

(71) Applicants: Norio Hanawa, Yokohama-shi (JP); Takashi Kinbara, Kawasaki-shi (JP); Miki Tagawa, Shinagawa-ku (JP)

(72) Inventors: Norio Hanawa, Yokohama-shi (JP); Takashi Kinbara, Kawasaki-shi (JP); Miki Tagawa, Shinagawa-ku (JP)

(73) Assignee: KONAMI DIGITAL ENTERTAINMENT CO., LTD., Tokyo (JP)

(21) Appl. No.: 14/354,136

(22) PCT Filed: Aug. 16, 2012
(86) PCT No.: PCT/JP2012/070839

§ 371 Date: Apr. 24, 2014

(30) Foreign Application Priority Data
Oct. 26, 2011 (JP) 2011-235507

(51) Int. Cl. G06F 3/01

(52) U.S. Cl. CPC G06F 3/017; G06F 3/011
USPC 345/156

(57) ABSTRACT

An image processing device includes an operation time information obtaining unit, a movement control unit, a movement target position determination unit and a movement manner determination unit. The operation time information obtaining unit obtains information on a period of time needed for a designation operation for designating a partial area in a screen. The movement control unit moves a virtual camera and/or an operation target object so as to approach a focus area in a virtual space displayed in the partial area. The movement target position determination unit determines a movement target position, based on a position in the virtual space, of the partial area and the size of the partial area. The movement manner determination unit determines a movement manner in the case of moving the virtual camera and/or the operation target object toward the movement target position, based on the period of time needed for the designation operation.

### TECHNICAL FIELD

The present invention relates to an image processing device, a method for controlling an image processing device, a program, and an information storage medium.

### BACKGROUND ART

There has been known an image processing device (for example, a game device, or the like) for displaying on a display unit a screen showing a virtual space, where at least one object is placed, viewed from a virtual camera. In such an image processing device, the virtual camera and/or a user s operation target object may move according to an operation by the user.

### CITATION LIST

### Patent Literature

Patent Literature 1: JP 2010-046219 A

### SUMMARY OF INVENTION

### Technical Problem

In a conventional image processing device, in the case of moving a virtual camera and/or an operation target object to a desired position in a desired manner (for example, a moving speed, means for movement, or the like), a user is required to perform an operation for designating a target position and an operation for designating a movement manner.

The present invention has been conceived in view of the above, and an object thereof is to provide an image processing device, a method for controlling an image processing device, a program, and an information storage medium capable of designating, through a single operation, a desired movement target position and a desired movement manner in the case of moving a virtual camera and/or an operation target object to a desired movement target position in a desired movement manner.

### Solution to Problem

In order to achieve the above described object, an image processing device according to the present invention is an image processing device for displaying on display means a screen showing a virtual space, where at least one object is placed, viewed from a virtual camera, the image processing device comprising: operation receiving means for receiving a designation operation for designating a partial area in the screen; operation time information obtaining means for obtaining information on a period of time needed for the designation operation; and movement control means for moving the virtual camera and/or an operation target object so as to approach a focus area in the virtual space displayed in the partial area, wherein the movement control means comprises: movement target position determination means for determining a movement target position for the virtual camera and/or the operation target object in the case of moving the virtual camera and/or the operation target object so as to approach the focus area, based on a position in the virtual space, of the designated partial area and a size of the designated partial area, movement manner determination means for determining a movement manner in the case of moving the virtual camera and/or the operation target object toward the movement target position, based on the period of time needed for the designation operation, and means for moving the virtual camera and/or the operation target object toward the movement target position in the movement manner determined by the movement manner determination means.

A method for controlling an image processing device according to the present invention is a method for controlling an image processing device for displaying on display means a screen showing a virtual space, where at least one object is placed, viewed from a virtual camera, the method comprising: an operation receiving step of receiving a designation operation for designating a partial area in the screen; an operation time information obtaining step of obtaining information on a period of time needed for the designation operation; and a movement control step of moving the virtual camera and/or an operation target object so as to approach a focus area in the virtual space displayed in the partial area, wherein the control step comprises: a movement target position determination step of determining a movement target position for the virtual camera and/or the operation target object in the case of moving the virtual camera and/or the operation target object toward the focus area, based on a position in the virtual space, of the designated partial area and a size of the designated partial area, a movement manner determination step of determining a movement manner in the case of moving the virtual camera and/or the operation target object toward the movement target position, based on the period of time needed for the designation operation, and a step of moving the virtual camera and/or the operation target object toward the movement target position in the movement manner determined at the movement manner determination step.

A program according to the present invention is a program for causing a computer to function as an image processing device for displaying on display means a screen showing a virtual space, where at least one object is placed, viewed from a virtual camera, the program for causing the computer to function as: operation receiving means for receiving a designation operation for designating a partial area in the screen; operation time information obtaining means for obtaining information on a period of time needed for the designation operation; and movement control means for moving the virtual camera and/or an operation target object so as to approach a focus area in the virtual space displayed in the partial area, wherein the movement control means comprises: movement target position determination means for determining a movement target position for the virtual camera and/or the operation target object in the case of moving the virtual camera and/or the operation target object so as to approach the focus area, based on a position in the virtual space, of the designated partial area and a size of the designated partial area, movement manner determination means for determining a movement manner in the case of moving the virtual camera and/or the operation target object toward the movement target position, based on the period of time needed for the designation operation, and means for moving the virtual camera and/or the operation target object toward the movement target position in the movement manner determined by the movement manner determination means.

An information storage medium according to the present invention is a computer readable information storage medium storing the above described program.

According to the present invention, it is possible to designate, through a single operation, a desired movement target position and a desired movement manner in the case of moving a virtual camera and/or an operation target object to the desired movement target position in the desired movement manner (for example, a moving speed, means for movement, or the like).

According to one aspect of the present invention, the movement manner determination means may determine a moving speed in the case of moving the virtual camera and/or the operation target object toward the movement target position, based on the period of time needed for the designation operation.

According to one aspect of the present invention, the movement manner determination means may comprise means for obtaining an operation speed of the designation operation, based on the period of time needed for the designation operation, and may determine the movement manner in the case of moving the virtual camera and/or the operation target object toward the movement target position, based on the operation speed of the designation operation.

According to one aspect of the present invention, the image processing device may further comprise means for displaying an image showing the partial area in the screen; and means for changing the display manner for the image showing the partial image, based on a result of comparison between a parameter of the operation target object and a parameter of an object included in the partial area.

### BRIEF DESCRIPTION OF DRAWINGS

FIG. 1 shows one example of a hardware structure of a game device (an image processing device) according to an embodiment of the present invention;

FIG. 2 shows one example of a virtual space;

FIG. 3 explains a virtual camera;

FIG. 4 shows one example of a game screen;

FIG. 5 explains an operation for moving a user character and the virtual camera;

FIG. 6 shows one example of the virtual space in the case where the user character and the virtual camera have moved to a movement target position;

FIG. 7 shows one example of the game screen in the case where the user character and the virtual camera have moved to the movement target position;

FIG. 8 shows one example of a correlation between an operation speed and a moving speed;

FIG. 9 is a function block diagram showing the game device (the image processing device) according to the embodiment of the present invention;

FIG. 10 explains one example of trace data;

FIG. 11 is a flowchart showing one example of processing executed in the game device;

FIG. 12 explains a surround condition;

FIG. 13 explains the surround condition;

FIG. 14 explains the surround condition;

FIG. 15 explains one example of a method for determining the movement target position;

FIG. 16 explains one example of the method for determining the movement target position;

FIG. 17 shows one example of a correlation between an area and a distance;

FIG. 18 explains one example of movement of the user character and the virtual camera;

FIG. 19 shows one example of a correlation between the operation time and the moving speed;

FIG. 20 explains one example of a correlation between a parameter difference and display manner information; and

FIG. 21 explains another example of the designation operation.

### DESCRIPTION OF EMBODIMENTS

In the following, an example of an embodiment of the present invention will be described in detail, based on the drawings. Below, a case will be described in which the present invention is applied to a game device that is one aspect of an image processing device. A game device (an image processing device) according to an embodiment of the present invention is implemented using, for example, a portable game device, a portable phone (a smart phone), a portable information terminal, a personal computer, a commercial game device, or a consumer game device (an installation type game device).

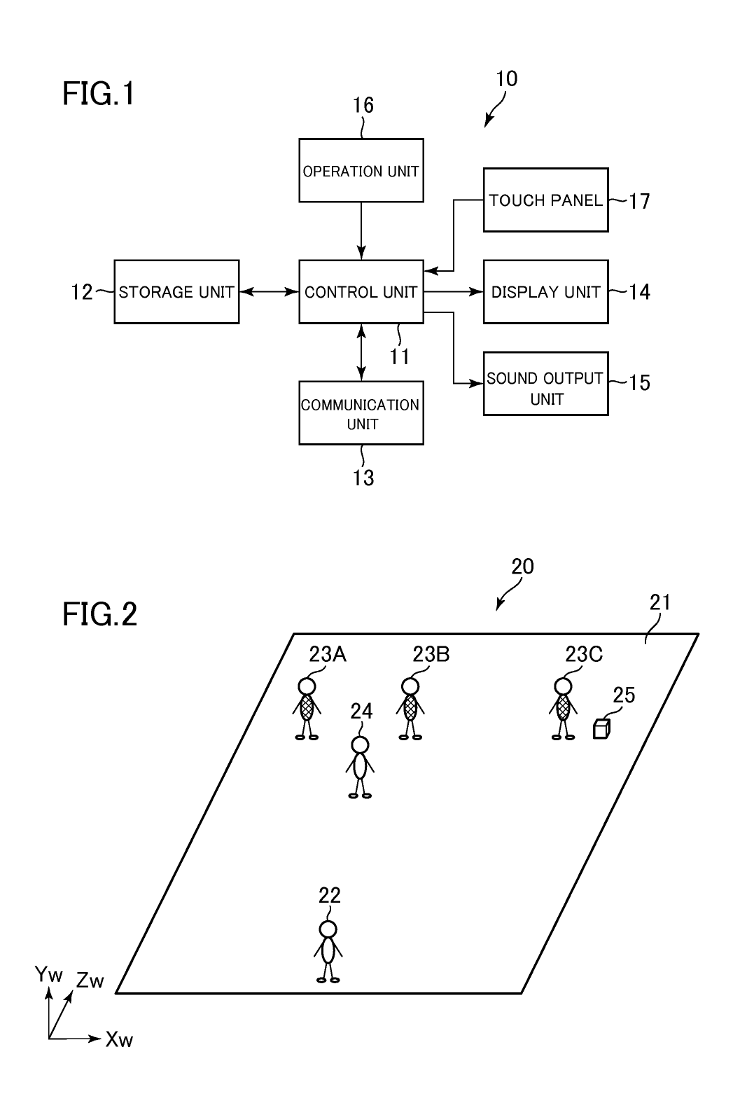

FIG. 1 shows one example of a hardware structure of the game device according to the embodiment of the present invention. As shown in FIG. 1, the game device 10 includes a control unit 11, a storage unit 12, a communication unit 13, a display unit 14, a sound output unit 15, an operation unit 16, and a touch panel 17.

The control unit 11 includes one or more microprocessors, for example. The control unit 11 executes processing for controlling the respective units of the game device 10 and information processing, based on an operating system or other programs stored in the storage unit 12.

The storage unit 12 includes a main memory unit and an auxiliary storage unit. The main memory unit is a RAM, for example, and a program and data read from the auxiliary storage unit are written into the main memory unit. The main memory unit is used also as a working memory of the control unit 11. The auxiliary storage unit includes a nonvolatile storage medium, such as, for example, a hard disk drive, a solid state drive, or the like, and a program and data are stored in the auxiliary storage unit.

The communication unit 13 is used for data communication via a communication network, such as the Internet or the like. For example, a program and data are supplied from a remote place to the game device 10 via the communication network, and stored in the storage unit 12 (the auxiliary storage unit).

The display unit 14 is a liquid crystal display, for example. The display unit 14 displays a screen according to an instruction from the control unit 11. The sound output unit 15 is a speaker or a headphone terminal, for example. The sound output unit 15 outputs sound (for example, music, sound effects, or the like) according to an instruction from the control unit 11. The operation unit 16 includes a button, a stick (a lever), a keyboard, or a mouse, for example, and is used by a user for operation.

The touch panel 17 is a general touch panel of a resistive type, a capacitive type, or the like, for example. The touch panel 17 detects a position touched by a user. The touch panel 17 supplies information in accordance with the position touched by the user to the control unit 11. The touch panel 17 is placed on the display unit 14 and used in order for a user to designate a position in a screen displayed on the display unit 14. For example, a position detected by the touch panel 17 (that is, a position touched by a user) is expressed according to a screen coordinate system. A screen coordinate system is an Xs Ys coordinate system having the upper left vertex of a screen displayed on the display unit 14 as the origin O, the horizontal direction (the rightward direction) as the Xs axial positive direction, and the vertical direction (the downward direction) as the Ys axial positive direction (see FIG. 4 to be described later).

The game device 10 may include an optical disk drive or a memory card slot. The optical disk drive is used to read a program and data recorded on an optical disk (an information recording medium), and the memory card slot is used to read a program and data stored in a memory card (an information storage medium). A program and data may be supplied to the game device 10 via an optical disk or a memory card, and stored in the storage unit 12 (the auxiliary storage unit).

The game device 10 executes various games, based on a game program stored in the storage unit 12. In the following, a case will be described in which the game device 10 executes a game in which a user operates a game character (hereinafter referred to as a “user character”) to fight off a game character (hereinafter referred to as an “opponent character”) opposing the user character.

When the game device 10 executes the above described game, a virtual space is generated in the storage unit 12 (the main storage unit). FIG. 2 shows one example of the virtual space. The virtual space 20 shown in FIG. 2 is a virtual 3D space where three orthogonal coordinate axes (the Xw axis, the Yw axis, and the Zw axis) are set. The position of an object or the like placed in the virtual space 20 is specified by these three coordinate axes. The Xw Yw Zw coordinate system will be hereinafter referred to as a “world coordinate system”.

As shown in FIG. 2, various objects are placed in the virtual space 20. For example, a field object (hereinafter simply referred to as a “field”) 21, or an object representing a field, is placed in the virtual space 20. Further, a user character object (hereinafter simply referred to as a “user character”) 22, or an object representing a user character, is placed in the field 21. Still further, opponent character objects (hereinafter simply referred to as an “opponent character”) 23A, 23B, 23C, or objects representing opponent characters, as well are placed in the field 21. The opponent characters 23A, 23B, 23C may be hereinafter collectively referred to as an “opponent character 23”.

Yet further, a teammate character object (hereinafter simply referred to as a “teammate character”) 24, or an object representing a teammate character of the user character 22, as well is placed in the field 21. In the situation shown in FIG. 2, two opponent characters 23A, 23B are approaching the teammate character 24.

Yet further, a treasury box object (hereinafter simply referred to as a “treasury box”) 25, or an object representing a treasury box, as well is placed in the field 21. In the situation shown in FIG. 2, the opponent character 23C is positioned near the treasury box 25.

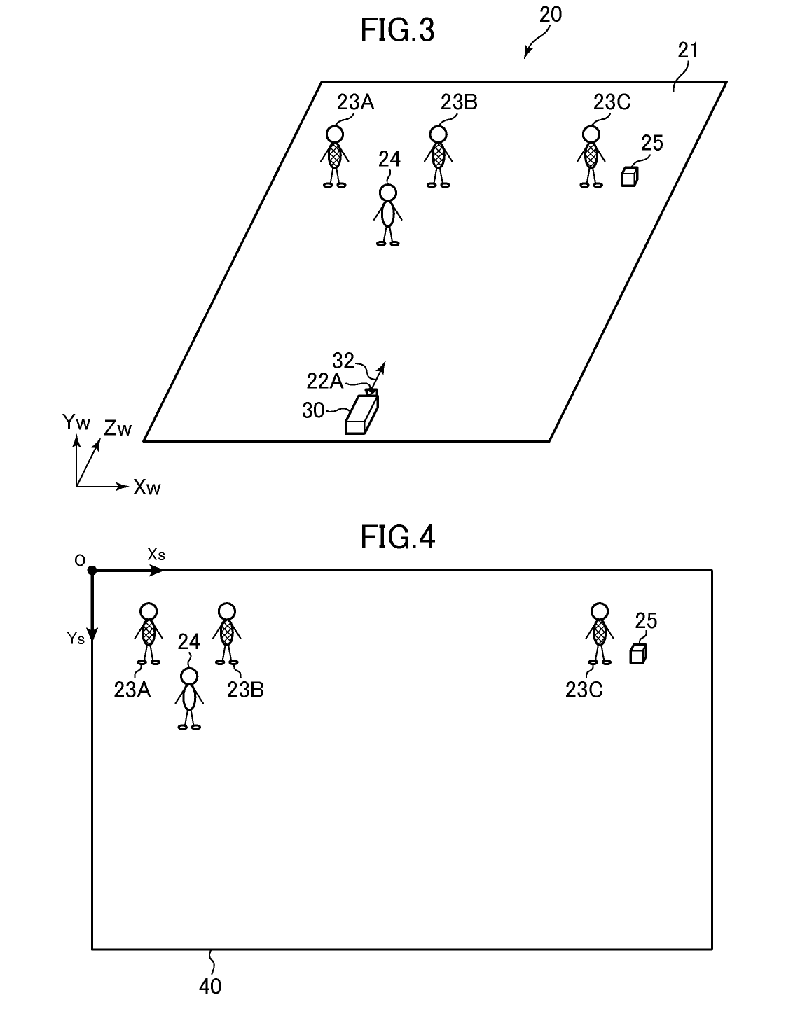

Yet further, a virtual camera (a viewpoint) is set in the virtual space 20. FIG. 3 explains the virtual camera. For example, the virtual camera 30 is set based on the position of the user character 22. More specifically, for example, the virtual camera 30 is set at a position 22A (for example, a middle position between the left eye and the right eye) in the head of the user character 22. In this case, the virtual camera 30 as well moves according to movement of the user character 22, such that the field of view of the virtual camera 30 is substantially coincident with that of the user character 22.

Alternatively, the virtual camera 30 may not be set at the position 22A in the head of the user character 22. For example, the virtual camera 30 may be set behind above the user character 22. In this case as well, the virtual camera 30 may move according to movement of the user character 22.

A screen showing the virtual space 20 viewed from the above described virtual camera 30 is displayed on the display unit 14. FIG. 4 shows one example of the screen. The screen 40 is generated by converting the coordinates of each vertex of an object placed in the virtual space 20 from the world coordinate system to the screen coordinate system through a matrix operation for converting a coordinate in the world coordinate system to that in the screen coordinate system.

When the virtual camera 30 is set at the position 22A in the head of the user character 22, as described above, the virtual space 20 viewed from the user character 22 is shown in the screen 40. In this case, a user plays the game while seeing the screen 40 showing the virtual space 20 viewed from the user character 22.

In the following, a technique is described for implementing a user interface in the above described game device 10 that enables a user to designate, through a single operation, a movement designation position for the user character 22 and the virtual camera 30 and a movement manner (for example, a moving speed) when the user character 22 and the virtual camera 30 move to the movement target position.

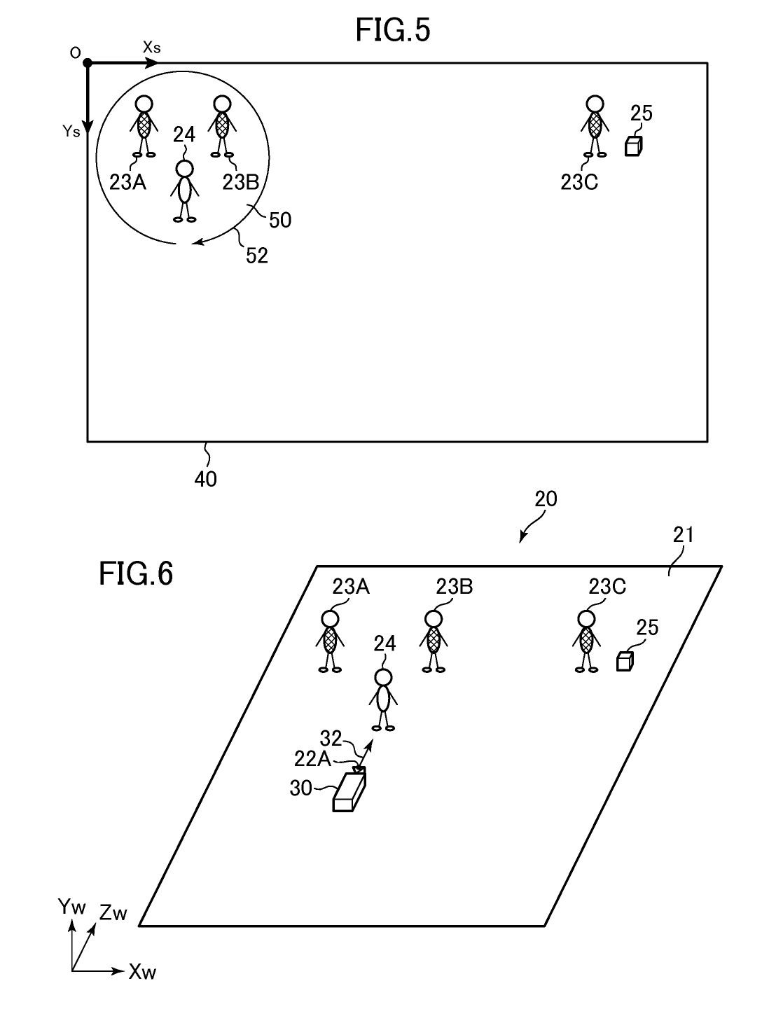

FIG. 5 explains an operation for moving the user character 22 and the virtual camera 30. In this embodiment, a user draws a line, or a trace 52 surrounding a partial area 50 in the screen 40, on the touch panel 17 to thereby designate a movement target position for the user character 22 and the virtual camera 30 and a moving speed (a movement manner) when the user character 22 and the virtual camera 30 move to the movement target position.

When the trace 52 surrounding the partial area 50 in the screen 40 is drawn, the user character 22 and the virtual camera 30 move toward an area (hereinafter referred to as a “focus area”) in the virtual space 20 displayed in the area 50. That is, the user character 22 and the virtual camera 30 approach the focus area.

In this case, such a position that the field of view of the user character 22 and the virtual camera 30 corresponds to the focus area is set as the movement target position for the user character 22 and the virtual camera 30. That is, such a position that the field of view of the user character 22 and the virtual camera 30 substantially coincides with the focus area is set as the movement target position for the user character 22 and the virtual camera 30.

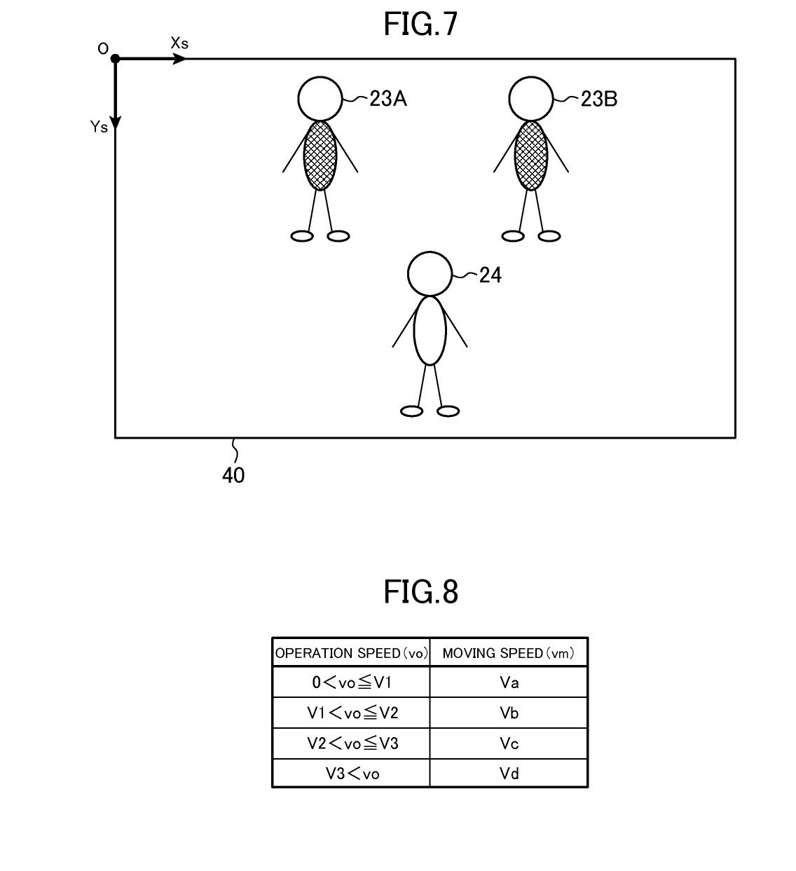

FIGS. 6 and 7 show one respective examples of the virtual space 20 and the screen 40 when the user character 22 and the virtual camera 30 have moved to the above mentioned movement target position. Note that although the user character 22 is not shown in FIG. 6, the user character 22 as well is placed at the position of the virtual camera 30, as the virtual camera 30 is set at the position 22A in the head of the user character 22, as described above.

The moving speed in the virtual space 20 when the user character 22 and the virtual camera 30 move from the current position to the movement target position is set based on the operation speed of the operation of drawing the trace 52. FIG. 8 shows one example of a correlation between the operation speed (vo) of the operation of drawing the trace 52 and the moving speed (vm) of the user character 22 and the virtual camera 30. The operation speed (vo) of the operation of drawing the trace 52 is calculated by dividing the length of the trace 52 by a period of time needed to draw the trace 52. In FIG. 8, “V1”, “V2”, and “V3” indicate predetermined operation speeds, and hold the relationship of “V1<V2<V3”. “Va”, “Vb”, “Vc”, and “Vd” indicate predetermined moving speeds, and hold the relationship of “Va<Vb<Vc<Vd”. The correlation shown in FIG. 8 is defined such that a faster operation speed (vo) of the operation of drawing the trace 52 results in a faster moving speed (vm) of the user character 22 and the virtual camera 30.

As described above, in the game device 10, a user can designate a movement target position for the user character 22 and the virtual camera 30 by drawing a trace 52 surrounding the area 50 in the screen 40. Further, the user can designate a moving speed (a movement manner) when the user character 22 and the virtual camera 30 move to the movement target position by adjusting the operation speed of the operation of drawing the trace 52. That is, in the game device 10, it is possible to designate both of the movement target position for the user character 22 and the virtual camera 30 and the moving speed (a movement manner) when the user character 22 and the virtual camera 30 move toward the movement target position, through a single intuitive operation of drawing the trace 52 surrounding the area 50 in the screen 40.

For example, in the situation shown in FIG. 2, two opponent characters 23A, 23B are approaching the teammate character 24. In such a case, in order to help the teammate character 24, the user quickly draws the trace 52 surrounding the opponent characters 23A, 23B, as shown in FIG. 5, for example, to thereby cause the user character 22 (and the virtual camera 30) to quickly move to the opponent characters 23A, 23B and the teammate character 24.

Meanwhile, in the situation shown in FIG. 2, the opponent character 23C is positioned near the treasure box 25. In such a case, in order to approach deliberately to the treasure box 25 while paying attention to the opponent character 23C, the user relatively slowly draws the trace 52 surrounding the opponent character 23C and the treasury box 25, to thereby cause the user character 22 (and the virtual camera 30) to slowly move to the opponent character 23C and the treasury box 25.

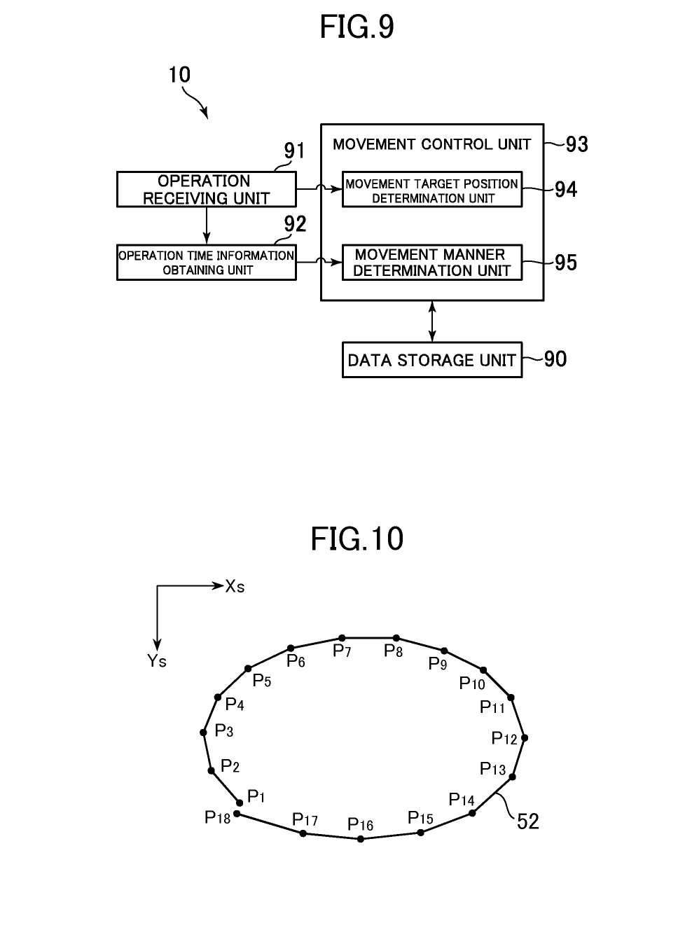

A structure for implementing the above described user interface will be described. FIG. 9 is a function block diagram showing a function block achieved in the game device 10. As shown in FIG. 9, the game device 10 comprises a data storage unit 90, an operation receiving unit 91, an operation time information obtaining unit 92, and a movement control unit 93. For example, the data storage unit 90 is achieved using the storage unit 12, while the other function blocks are achieved by the control unit 11 executing a program read from the storage unit 12.

Initially, the data storage unit 90 will be described. Data necessary to execute a game is stored in the data storage unit 90. For example, model data on respective objects placed in the virtual space 20 and motion data on the user character 22, the opponent character 23, and the teammate character 24 are stored in the data storage unit 90.

Further, parameter data on the user character 22, the opponent character 23, and the teammate character 24 are also stored in the data storage unit 90. For example, parameters mentioned below are included in the parameter data:

strength parameter indicating strength (for example, attack parameter, defense parameter, or the like); and

hit point parameter indicating remaining physical power or accumulated damages.

State data indicating the current state of the virtual space 20 is stored in the data storage unit 90. For example, data such as is mentioned below is included in the state data:

data indicating a state of the user character 22 (position, movement direction, moving speed, and the like);

data indicating a state of the opponent character 23 (position, movement direction, moving speed, and the like);

data indicating a state of the teammate character 24 (position, movement direction, moving speed, and the like); and

data indicating a state of the virtual camera 30 (position, sight line direction, angle of view, and the like).

In the following, the operation receiving unit 91 will be described. The operation receiving unit 91 receives an operation for designating an area 50 in the screen 40 (hereinafter referred to as a “designation operation”).

In this embodiment, the operation of drawing the trace 52 surrounding the area 50 in the screen 40 corresponds to the “designation operation”. That is, in this embodiment, the operation receiving unit 91 obtains a position on the touch panel 17 designated (touched) by the user for every predetermined period of time (for example, 1/60^{th} of a second), based on the position information supplied from the touch panel 17 for every predetermined period of time (for example, 1/60^{th} of a second) while a finger of the user remains touching the touch panel 17. Then, the operation receiving unit 91 obtains the trace of the position designated (touched) by the user. In this case, a set of designated positions (touched positions) by the user obtained for every predetermined period of time while the finger of the user remains touching the touch panel 17 is obtained as the trace data. This trace data is stored in the storage unit 12.

FIG. 10 explains one example of the trace data. As shown in FIG. 10, the trace data includes a plurality of positions (positions P₁ to P₁₈ here) on the trace 52. In FIG. 10, the position P₁ is the start point of the trace 52. That is, the position P₁ is a position touched when touching the touch panel 17 is started. The position P₁₈ is the end point of the trace 52. That is, the position P₁₈ is a position touched when touching the touch panel 17 is ended.

The operation time information obtaining unit 92 will be described. The operation time information obtaining unit 92 obtains information on a period of time needed to perform the designation operation (hereinafter referred to as an “operation time”).

For example, the operation time information obtaining unit 92 obtains a time at which the designation operation is started. In addition, the operation time information obtaining unit 92 obtains a time at which the designation operation is ended. Then, the operation time information obtaining unit 92 obtains a period of time elapsed after the start time until the end time as information on the operation time.

Alternatively, when the designation operation is started, the operation time information obtaining unit 92 initializes a numeric value stored in the storage unit 12 to the initial value (for example, 0). Further, during a period until the end of the designation operation, the operation time information obtaining unit 92 increases (or decreases) the above mentioned numeric value stored in the storage unit 12 by a predetermined amount (for example, one) for every predetermined period of time (for example, 1/60^{th} of a second). Then, when the designation operation is ended, the operation time information obtaining unit 92 obtains the difference between the above mentioned numeric value stored in the storage unit 12 and the initial value as information on the operation time.

As described above, in this embodiment, the operation of drawing the trace 52 surrounding the partial area 50 in the screen 40 corresponds to the “designation operation”. Therefore, the period of time needed to draw the trace 52 surrounding the area 50 in the screen 40 corresponds to the “operation time” in this embodiment.

For the trace data shown in FIG. 10, for example, the period of time from a moment at which a finger of the user touches the position P₁ to a moment at which the finger of the user, having moved to the position P₁₈, is detached from the touch panel 17 corresponds to the “operation time”. Note that as a touched position touched by the user is obtained for every predetermined period of time (for example, 1/60^{th} of a second), assuming that the number of positions P₁ to P₁₈ included in the trace data (eighteen in the case shown in FIG. 10) as N, and the predetermined period of time as ΔT, the operation time (t) is obtained by the expression (1) mentioned below.

t=(N−1)*ΔT (1)

The movement control unit 93 will be described. The movement control unit 93 moves the virtual camera 30 and/or an operation target object for the user, based on the area 50 in the screen 40 designated through the designation operation. An “operation target object” is an object operated by the user among the objects placed in the virtual space 20. In this embodiment, the user character 22 corresponds to the “operation target object”.

The movement control unit 93 moves the user character 22 (the operation target object) and/or the virtual camera 30 so as to approach an area (the focus area) in the virtual space 20 displayed in the area 50 in the screen 40 designated through the designation operation.

As shown in FIG. 9, the movement control unit 93 comprises a movement target position determination unit 94 and a movement manner determination unit 95.

The movement target position determination unit 94 determines a movement target position for the user character 22 and/or the virtual camera 30 when moving the user character 22 and the virtual camera 30 so as to approach the focus area. The movement target position determination unit 94 determines the above described movement target position, based on a position in the virtual space 20 displayed in the area 50 in the screen 40 designated through the designation operation, and the size of the area 50. The “size of the area 50” may be the size of the area 50 in, for example, the screen 40 (the screen coordinate system) or in the virtual space 20 (the world coordinate system). Note that the “size of the area 50 in the virtual space 20” refers to the size of an area (that is, the focus area) in the virtual space 20 corresponding to the area 50.

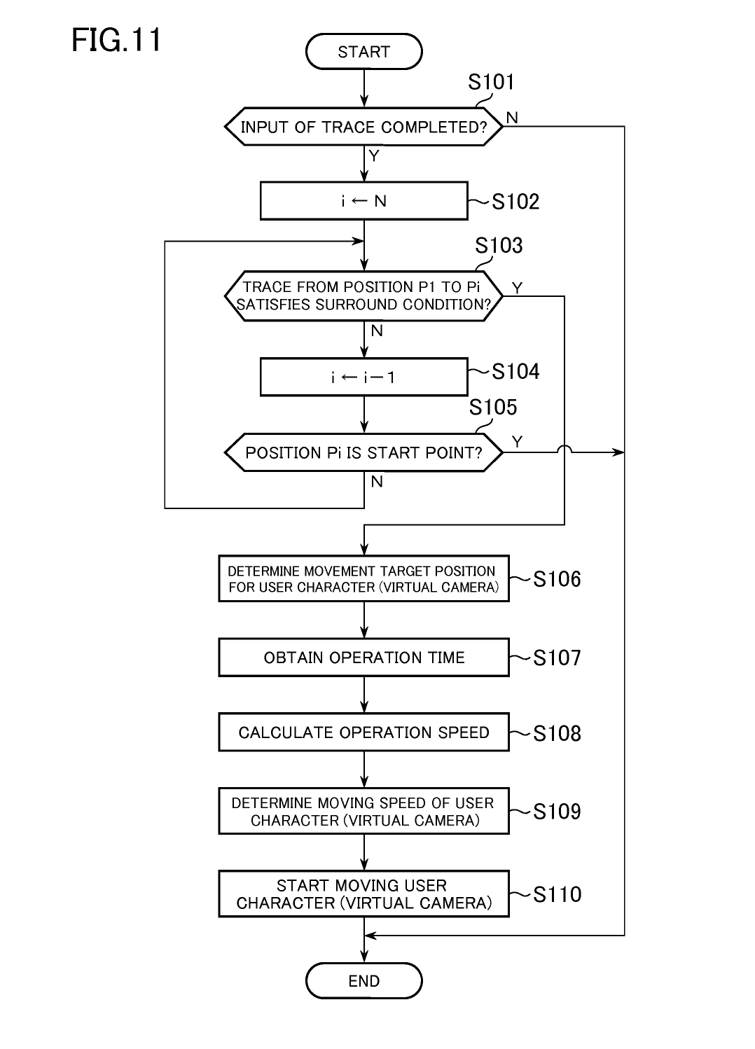

For example, the movement target position determination unit 94 determines, as the movement target position for the user character 22, such a position that an area in the virtual space 20 viewed from the user character 22 (that is, the field of view of the user character 22) corresponds to the focus area (in other words, such a position that the area in the virtual space 20 viewed from the user character 22 substantially coincides with the focus area). Further, for example, the movement target position determination unit 94 determines, as the movement target position for the virtual camera 30, such a position that an area in the virtual space 20 viewed from the virtual camera 30 (that is, the field of view of the virtual camera 30) corresponds to the focus area (in other words, such a position that the area in the virtual space 20 viewed from the virtual camera 30 substantially coincides with the focus area). Details on an operation of the movement target position determination unit 94 will be described later (see step S106 in FIG. 11 to be described later).

The movement manner determination unit 95 determines a movement manner when the user character 22 and/or the virtual camera 30 move/moves toward the movement target position, based on the period of time needed for the designation operation (the operation time). For example, the “movement manner when the user character 22 and/or the virtual camera 30 move/moves toward the movement target position” refers to a moving speed when the user character 22 and/or the virtual camera 30 move/moves toward the movement target position. Further, for example, in the case where the user character 22 moves by means of movement means selected from among a plurality of movement means (for example, a vehicle), the “movement manner when the user character 22 moves toward the movement target position” refers to a movement means used by the user character 22 moving toward the movement target position.

In order to achieve the movement manner determination unit 95, correlation information indicating a correlation between, for example, a condition on a period of time needed to perform the designation operation (the operation time) and a movement manner is stored in the data storage unit 90. More specifically, correlation information such as is shown in FIG. 8, for example, is stored in the data storage unit 90. The correlation information shown in FIG. 8 is one example of information indicating a correlation between the operation speed (vo) of the operation of drawing the trace 52 and the moving speed (vm). Note that although the correlation information shown in FIG. 8 is table information indicating the above described correlation, the correlation information may be expression information for calculating the moving speed (vm) based on the operation speed (vo).

As described above, the operation of drawing the trace 52 surrounding the area 50 in the screen 40 corresponds to the “designation operation” in this embodiment. Therefore, the period of time needed to draw the trace 52 corresponds to the “operation time”. Further, the operation speed of the operation of drawing the trace 52 is calculated based on the operation time of the operation of drawing the trace 52. That is, the operation speed of the operation of drawing the trace 52 is calculated by dividing the length of the trace 52 by the period of time needed to draw the trace 52 (the operation time). Therefore, in the correlation information shown in FIG. 8, the range of the operation speed corresponds to the condition on the operation time of the operation of drawing the trace 52, and resultantly, to the “condition on the period of time needed to perform the designation operation (the operation time)”.

Based on the above described correlation information, the movement manner determination unit 95 determines the moving speed when the user character 22 and/or virtual camera 30 are caused to move toward the movement target position. That is, the movement manner determination unit 95 selects a moving speed correlated to the condition satisfied by the period of time needed to perform the designation operation (the operation time). For example, in the case where the correlation information shown in FIG. 8 is stored, the movement manner determination unit 95 selects a moving speed correlated to the range to which the operation speed of the operation of drawing the trace 52 belongs.

The movement control unit 93 moves the user character 22 and/or the virtual camera 30 toward the movement target position in the movement manner determined by the movement manner determination unit 95.

In the following, processing that is executed in the game device 10 will be described. FIG. 11 is a flowchart showing one example of processing relevant to the present invention among those executed in the game device 10. For example, the processing shown in FIG. 11 is processing that is repetitively executed for every predetermined period of time (for example, 1/60^{th} of a second). The control unit 11 executes the processing shown in FIG. 11 according to the program stored in the storage unit 12, to thereby function as the operation receiving unit 91, the operation time information obtaining unit 92, and the movement control unit 93.

As shown in FIG. 11, the control unit 11 (the operation receiving unit 91) determines whether or not input of the trace 52 is completed (S101). When it is determined that input of the trace 52 is not yet completed, the control unit 11 ends this processing. Meanwhile, when it is determined that input of the trace 52 is completed, the control unit 11 initializes the value of the variable i to N (S102). Note that it is assumed here that the positions P₁ to P_{N} are included in the trace data indicating the trace 52 input by the user. That is, “N” indicates the total number of positions included in the trace data. In other words, “N” indicates the total number of positions detected by the touch panel 17 while the trace 52 is being input. For example, for the trace data shown in FIG. 10, the value of “N” is 18.

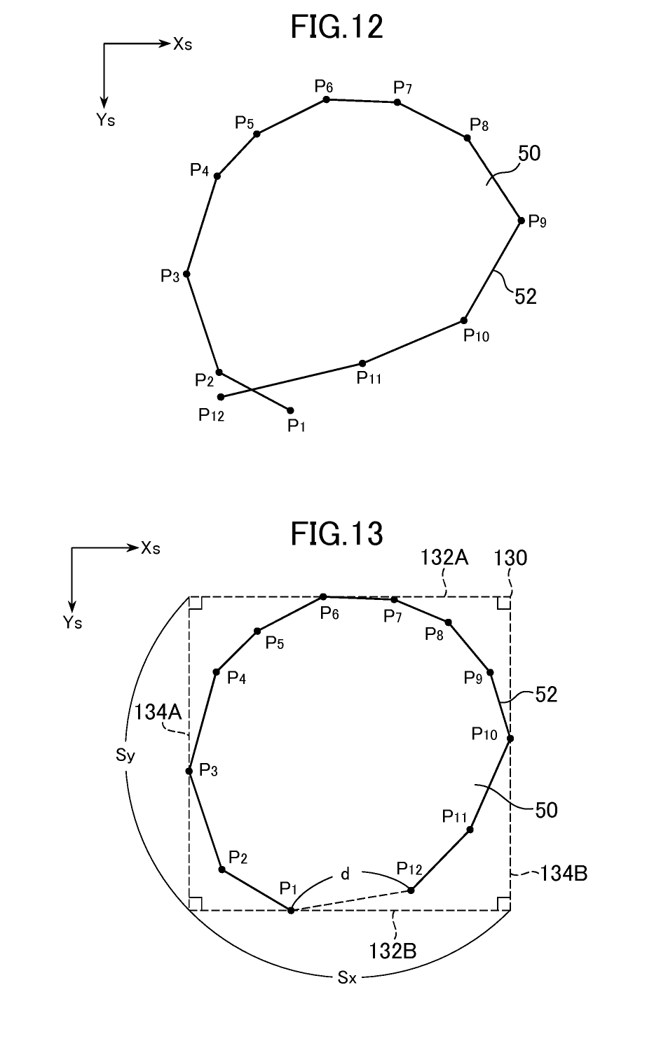

After execution of the processing at step S102, the control unit 11 determines whether or not the trace 52 extending from the position P₁ to the position Pᵢ satisfies a surround condition, while referring to the trace data (S103). The “surround condition” refers to a condition for determination that the area 50 in the screen 40 is surrounded by the trace 52. In this embodiment, the two kinds of conditions A, B mentioned below are set as the surround conditions. FIGS. 12, 13, and 14 explain the surround condition.

[Condition A] The straight line from the position Pᵢ₋₁ to the position Pᵢ intersects the straight line from the position Pᵢ₋ⱼ₋₁ to the position Pᵢ₋ⱼ (2≦j≦i−2).
[Condition B] The straight distance d between the position P₁ and the position Pᵢ is equal to or shorter than a reference distance Dr, and the positions P₂ to Pᵢ₋₁ includes such a position that the straight distance thereto from the position P₁ is equal to or longer than the reference distance Dr.

Initially, the condition A will be described. Assume here a case in which, for example, the trace 52 extending from the position P₁ to the position Pᵢ is the trace 52 extending from the position P₁ to the position P₁₂ shown in FIG. 12. In this case, as the straight line from the position P₁₁ to the position P₁₂ intersects the straight line from the position P₁ to the position P₂, the trace 52 extending from the position P₁ to the position P₁₂, shown in FIG. 12, satisfies the condition A.

In the following, the condition B will be described. Assume here a case in which, for example, the trace 52 extending from the position P₁ to the position Pᵢ is the trace 52 extending from the position P₁ to the position P₁₂ shown in FIG. 13.

In this embodiment, in determination as to whether or not the condition B is satisfied, the reference distance Dr is initially set. For example, the reference distance Dr is set based on at least either one of the difference between the maximum value and the minimum value of the Xs axial coordinates of the positions P₁ to P₁₂ and the difference between the maximum value and the minimum value of the Ys axial coordinates of the positions P₁ to P₁₂.

Specifically, the reference distance Dr is set based on the size of a rectangle 130 that contains the trace 52 extending from the position P₁ to the position P₁₂, such as is shown in FIG. 13, for example. Note that the horizontal side 132A of the rectangle 130 is a side passing through the position P₆ with the minimum Y axial coordinate and being parallel to the Xs axial direction, and the horizontal side 132B is a side passing through the position P₁ with the maximum Y axial coordinate and being parallel to the X axis direction. The vertical side 134A of the rectangle 130 is a side passing through the position P₃ with the minimum X axial coordinate and being parallel to the Ys axial direction, and the vertical side 134B is a side passing through the position P₁₀ with the maximum X axial coordinate and being parallel to the Ys axial direction.

Assuming that the length of the horizontal side 132A, 132B of the rectangle 130 as Sx, and that of the vertical side 134A, 134B as Sy, the reference distance Dr is determined by the expression (2) mentioned below.

Dr=((Sx/2)²+(Sy/2)²)^{1/2} (2)

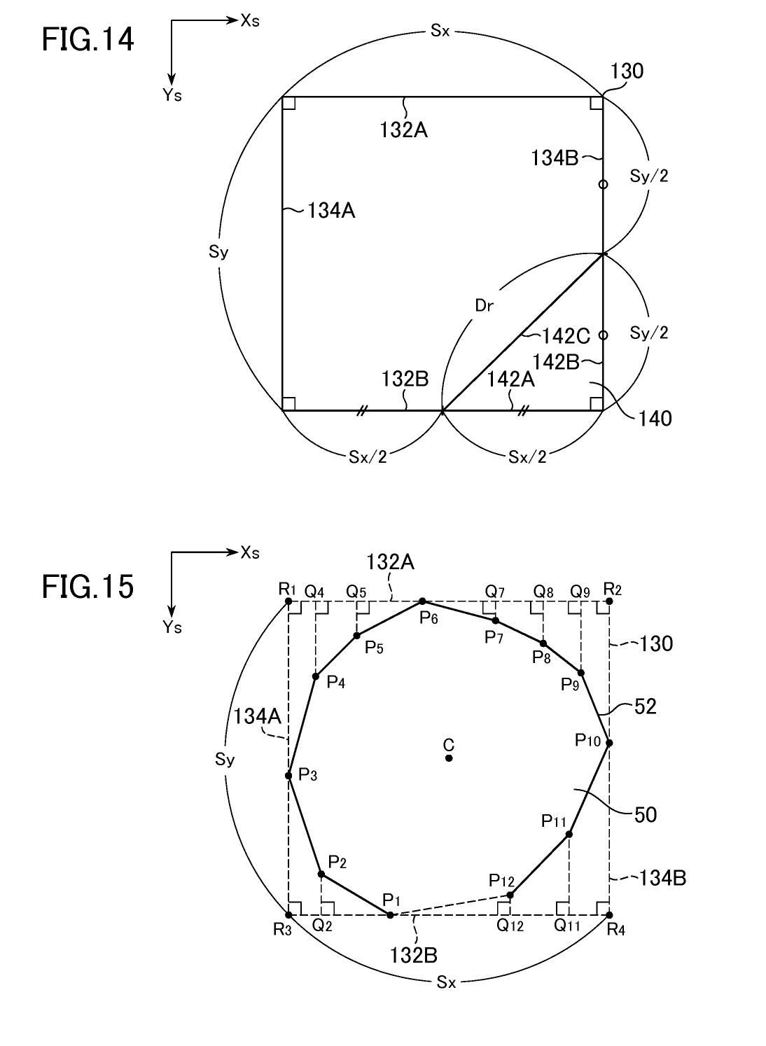

In the case where the reference distance Dr is determined by the expression (2) mentioned above, the length of the hypotenuse 142C of a right angle triangle 140 having two sides 142A, 142B other than the hypotenuse 142C, of lengths being Sx/2, Sy/2, respectively, is set as the reference distance Dr, as shown in FIG. 14, for example. Note that the expression for calculating the reference distance Dr is not limited to the expression (2) mentioned above, and the reference distance Dr may be calculated by other expression. Alternatively, the reference distance Dr may be predetermined.

In the example shown in FIG. 13, as the straight distance d between the position P₁ and the position P₁₂ is equal to or shorter than the reference distance Dr, and there is a position (for example, the position P₆) with the straight distance thereto from the position P₁ being equal to or longer than the reference distance Dr among the positions P₂ to P₁₁, the trace 52 extending from the position P₁ to the position P₁₂ satisfies the condition B shown in FIG. 13.

When it is determined at step S103 that the trace 52 extending from the position P₁ to the position Pᵢ does not satisfy either of the above described conditions A, B, that is, when it is determined that the trace 52 extending from the position P₁ to the position Pᵢ does not satisfy the surround condition, the control unit 11 decreases the value of the variable i by one (S104). Then, the control unit 11 determines whether or not the position Pᵢ is a start point (S105).

A case with determination that the position Pᵢ is the start point refers to a case in which the trace 52 input by the user is not a trace surrounding the area 50 in the screen 40. In this case, the control unit 11 ends this processing. Meanwhile, a case with determination that the position Pᵢ is not the start point, the control unit 11 executes the processing at step S103.

Meanwhile, when it is determined at step S103 that the trace 52 extending from the position P₁ to the position Pᵢ satisfies the surround condition, that is, when it is determined that the trace 52 extending from the position P₁ to the position Pᵢ satisfies at least one of the conditions A, B mentioned above, the control unit 11 (the movement target position determination unit 94) determines a movement target position for the user character 22 (the virtual camera 30) (S106). The control unit 11 executes predetermined processing based on the position and size of the area 50 in the screen 40 surrounded by the trace 52 extending from the position P₁ to the position Pᵢ, to thereby determine the movement target position for the user character 22 (the virtual camera 30).

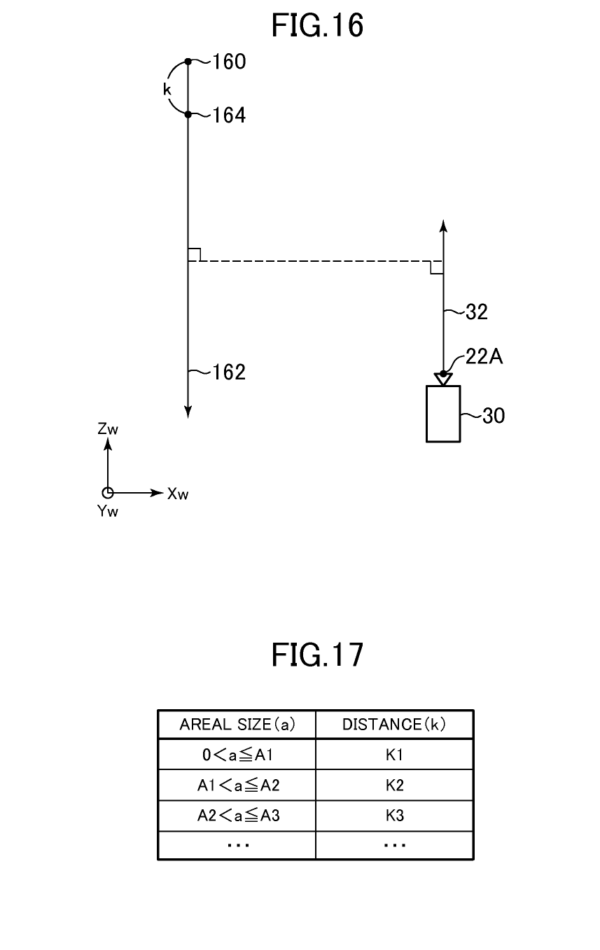

FIGS. 15 and 16 explain one example of a method for determining the movement target position for the user character 22 (the virtual camera 30). In the following, assume a case in which, for example, the trace 52 extending from the position P₁ to the position Pᵢ is the trace 52 extending from the position P₁ to the position P₁₂ shown in FIG. 15.

Note that, in FIG. 15, the rectangle 130 is a rectangle obtained in the same manner as that for the rectangle 130 in FIG. 13. The position Qᵢ (i=2, 4, 5, 7 to 9, 11, 12) indicates a foot of a perpendicular line extending from the position Pᵢ to the vertical side 134A, the vertical side 134B, the horizontal side 132A, or the horizontal side 132B of the rectangle 130. For example, the position Q₄ is a foot of a perpendicular line extending from the position P₄ to the horizontal side 132A of the rectangle 130. Further, R₁, R₂, R₃, R₄ indicate respective vertexes of the rectangle 130.

At step S106, initially, the control unit 11 obtains information on the position and size of the area 50 surrounded by the trace 52 extending from the position P₁ to the position P₁₂.

A method for obtaining information on the position of the area 50 surrounded by the trace 52 extending from the position P₁ to the position P₁₂ will be described. For example, the control unit 11 obtains the representative position in the area 50 surrounded by the trace 52 as the information on the position of the area 50 surrounded by the trace 52 extending from the position P₁ to the position P₁₂. For example, as shown in FIG. 15, the control unit 11 obtains the center point C of the rectangle 130 containing the trace 52 as the above mentioned representative position.

Note that the control unit 11 may obtain the position of any object included in the area 50 surrounded by the trace 52 as the above described representative position. For example, the control unit 11 may obtain the position of an object positioned closest to the user character 22 (or the virtual camera 30) among the objects included in the area 50 surrounded by the trace 52 as the above mentioned representative position. For example, when the opponent character 23 and the teammate character 24 are included in the area 50 surrounded by the trace 52, and the teammate character 24 is positioned closer to the user character 22 (or the virtual camera 30) than the opponent character 23, the control unit 11 may obtain the position of the teammate character 24 as the above mentioned representative position.

In the following, a method for obtaining information on the size of the area 50 surrounded by the trace 52 extending from the position P₁ to the position P₁₂ will be described. Below, a case will be described in which information on the size of the area 50 in the screen 40 (the screen coordinate system) is obtained as the information on the size of the area 50 surrounded by the trace 52.

For example, the control unit 11 obtains the areal size of the area 50 surrounded by the trace 52 as the information on the size of the area 50 surrounded by the trace 52 extending from the position P₁ to the position P₁₂. For example, the control unit 11 subtracts the areal size of areas other than the area 50 surrounded by the trace 52 from the areal size of the rectangle 130 to thereby obtain the areal size of the area 50 surrounded by the trace 52. Note that in the example shown in FIG. 15, the areal size of the areas other than the area 50 surrounded by the trace 52 is obtained by adding the areal sizes of the triangles and quadrangles mentioned below:

triangles P₁P₂Q₂, P₁P₁₂Q₁₂, P₆P₅Q₅, P₆P₇Q₇

squares P₂P₃R₃Q₂, P₃P₄Q₄R₁, P₄P₅Q₅Q₄, P₇P₈Q₈Q₇, P₈P₉Q₉Q₈, P₉P₁₀R₂Q₉, P₁₀P₁₁Q₁₁R₄, P₁₁P₁₂Q₁₂Q₁₁

Note that as the information on the size of the area 50 surrounded by the trace 52, information on the size of the area 50 in the virtual space 20 (the world coordinate system) may be obtained instead of the information on the size of the area 50 in the screen 40 (the screen coordinate system). For example, the control unit 11 may specify an area (that is, the focus area) in the virtual space 20 corresponding to the area 50 surrounded by the trace 52, and obtain information on the size of the area (the focus area).

After obtaining the information on the position and size of the area 50 surrounded by the trace 52 extending from the position P₁ to the position P₁₂, the control unit 11 determines a movement target position for the user character 22 (the virtual camera 30) based on the information. With reference to FIG. 16, one example of a method for determining the movement target position for the user character 22 (the virtual camera 30) will be described.

Initially, the control unit 11 obtains a position in the virtual space 20 corresponding to the representative position (for example, the center point C of the rectangle 130 in FIG. 15) of the area 50 surrounded by the trace 52. For example, the control unit 11 converts the screen coordinates of the above mentioned representative position into coordinates in the world coordinate system, based on a matrix operation for converting a coordinate in the screen coordinate system to that in the world coordinate system, to thereby obtain the position in the virtual space 20 corresponding to the above mentioned representative position. The reference numeral “160” in FIG. 16 indicates the position in the virtual space 20 corresponding to the above mentioned representative position.

Thereafter, the control unit 11 obtains, as the movement target position for the user character 22 (the virtual camera 30), a position 164 obtained by moving on a straight line 162 in parallel to the sight line direction 32 of the virtual camera 30 in the direction opposite from the sight line direction 32 of the virtual camera 30 from the position 160 obtained as described above. In this case, the control unit 11 determines the distance (k) between the position 160 and the position 164 based on the areal size of the area 50 surrounded by the trace 52.

In order to determine the above described distance (k) based on the areal size of the area 50 surrounded by the trace 52, correlation information on a correlation between the areal size of the area 50 and the distance (k) is necessary.

FIG. 17 shows one example of the above mentioned correlation information. In FIG. 17, “A1”, “A2”, and “A3” indicate predetermined areal sizes, and hold the relationship of “A1<A2<A3”. “K1”, “K2”, and “K3” indicate predetermined distances, and hold the relationship of “K1<K2<K3”. In the correlation information shown in FIG. 17, a larger areal size (a) of the area 50 surrounded by the trace 52 results in a longer distance (k). The correlation information shown in FIG. 17 is set such that the field of view of the user character 22 (the virtual camera 30) corresponds to (substantially coincides with) an area (the focus area) in the virtual space 20 displayed in the area 50 surrounded by the trace 52.

For example, in the case where the correlation information such as is shown in FIG. 17 is stored, the control unit 11 selects the distance (k) correlated to the range to which the areal size (a) of the area 50 surrounded by the trace 52 belongs. Note that although the correlation information shown in FIG. 17 is table information showing the above mentioned correlation, the correlation information may be expression information for calculating the distance (k) based on the areal size (a).

After execution of the processing at step S106, the control unit 11 (the operation time information obtaining unit 92) obtains the period of time needed to perform the operation of drawing the trace 52 (the operation time) (S107), as shown in FIG. 11. That is, the control unit 11 calculates the period of time needed to draw the trace 52 extending from the position P₁ to the position Pᵢ (the operation time). This operation time (t) is calculated by the expression (1) mentioned above. In this case, the value of the variable i corresponds to the value of “N” in the expression (1) mentioned above.

Further, the control unit 11 calculates the operation speed of the operation of drawing the trace 52 (S108). That is, the control unit 11 calculates the operation speed when the trace 52 extending from the position P₁ to the position Pᵢ is drawn.

For example, the control unit 11 obtains the length of the trace 52 extending from the position P₁ to the position Pᵢ. The length (L) of the trace 52 is calculated by the expression (3) mentioned below. Note that in the expression (3) mentioned below, “Dᵢ₋₁” indicates the straight distance between the position and the position Pᵢ. For example, “D₁” indicates the distance between the position P₁ and the position P₂.

L=D₁+D₂+ +Dᵢ₋₁ (3)

Then, based on the length (L) of the trace 52 extending from the position P₁ to the position Pᵢ and the period of time needed to draw the trace from the position P₁ to the position Pᵢ (the operation time: t), the control unit 11 calculates the operation speed when the trace 52 from the position P₁ to the position Pᵢ is drawn. That is, the control unit 11 divides the length (L) of the trace by the operation time (t) to thereby calculate the operation speed.

Note that the control unit 11 may calculate at steps S107 and S108 the operation time and the operation speed, respectively, when the trace 52 from the position P₁ (start point) to the position P_{N} (end point) is drawn.

After execution of the processing at step S108, the control unit 11 (the movement manner determination unit 95) determines the moving speed of the user character 22 (the virtual camera 30) (S109). For example, the control unit 11 determines the moving speed based on the operation speed determined at step S109 and the correlation information shown in FIG. 8. That is, the control unit 11 obtains the moving speed correlated to the operation speed calculated at step S108.

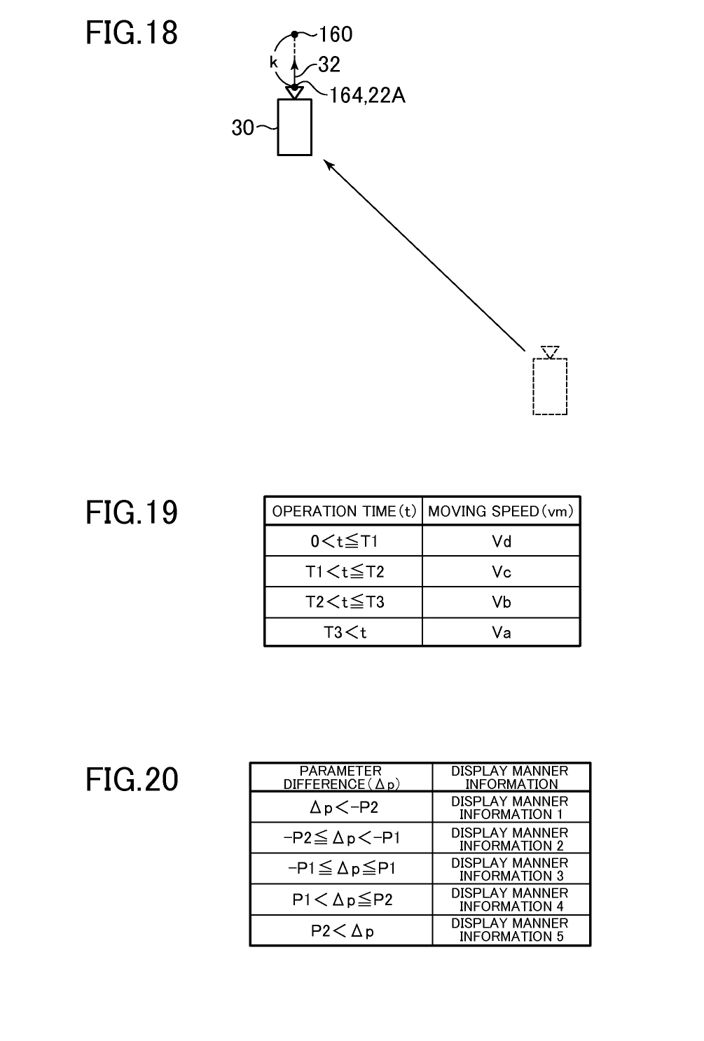

After completion of the processing at step S109, the control unit 11 (the movement control unit 93) causes the user character 22 (the virtual camera 30) to start moving toward the movement target position determined at step S106 (S110). In this case, the control unit 11 moves the user character 22 and the virtual camera 30 to the movement target position (see FIG. 18). In addition, in this case, the control unit 11 moves the user character 22 (the virtual camera 30) at the moving speed determined at step S109. With the above, the processing shown in FIG. 11 is finished.

According to the above described game device 10, it is possible to designate both of a movement target position for the user character 22 and the virtual camera 30 and a movement manner (the moving speed) when the user character 22 and the virtual camera 30 move toward the movement target position, through a single intuitive operation of drawing the trace 52 surrounding the area 50 in the screen 40. That is, according to the game device 10, it is possible to achieve a user interface capable of designating, through a single intuitive operation, both of the movement target position for the user character 22 and the virtual camera 30 and the movement manner (the moving speed) when the user character 22 and the virtual camera 30 move toward the movement target position.

The present invention is not limited to the above described embodiments.

(1) Instead of the correlation information shown in FIG. 8, correlation information shown in FIG. 19, for example, may be stored. The correlation information shown in FIG. 19 is information indicating a correlation between the operation time (t) needed for the designation operation (the operation of drawing the trace 52) and the moving speed (vm), being information for obtaining the moving speed (vm) directly based on the operation time (t). “T1”, “T2”, and “T3” in FIG. 19 indicate predetermined periods of time and hold the relationship of “T1<T2<T3”. “Va”, “Vb”, “Vc”, and “Vd” are similar to those in FIG. 8. In the correlation information shown in FIG. 19, a shorter operation time (t) results in a faster moving speed (vm).

In the case where the correlation information shown in FIG. 19 is stored, the processing at S108 in FIG. 11 is unnecessary. Further, although the correlation information shown in FIG. 19 is table information, the correlation information may be expression information for calculating the moving speed (vm) based on the operation time (t).

(2) The control unit 11 may display in the screen 40 an image (hereinafter referred to as an “area image”) showing the area 50 in the screen 40 designated through the designation operation. Further, when an opponent character 23 is included in the area 50 in the screen 40 designated through the designation operation 50, the control unit 11 may change the display manner for the area image, based on the result of comparison between a parameter of the user character 22 and that of the opponent character 23.

In this embodiment, for example, the image showing the trace 52 corresponds to the “area image”. For example, “to change the display manner for the area image” includes to change the color or the like of the area image. Further, in the case where the area image is a line defining the boundary of the area 50 designated through the designation operation, “to change the display manner for the area image” includes to change the thickness, kind, and so forth, of the line.

Further, for example, the “result of comparison between the parameter of the user character 22 and that of the opponent character 23” refers to a “difference (large/small) between the parameter of the user character 22 and the parameter of the opponent character 23”. More specifically, the above described “result of comparison” refers to a difference (large/small) between the hit point parameter of the user character 22 and the hit point parameter of the opponent character 23. Alternatively, the above described “result of comparison” refers to a difference (large/small) between the strength parameter of the user character 22 and the strength parameter of the opponent character 23.

Note that when a plurality of opponent characters 23 are included in the area 50 surrounded by the trace 52, a statistical value (for example, the average, the maximum value, or the like) of the parameters of the plurality of opponent characters 23 may be used as the above mentioned “parameter of the opponent character 23”. Alternatively, a parameter of any opponent character 23 among the plurality of opponent characters 23 may be used as the above mentioned “parameter of the opponent character 23”.

In order to change the display manner for the area image based on the result of comparison between the parameter of the user character 22 and the parameter of the opponent character 23, correlation information indicating a correlation between the above mentioned result of comparison and the display manner for the area image is necessary. FIG. 20 shows one example of the correlation information.

According to the correlation information shown in FIG. 20, a correlation between the difference (Δp) between the parameter of the user character 22 and the parameter of the opponent character 23 and the display manner information indicating a display manner for the area image is determined. In FIG. 20, a case with the value of “Δp” being a positive value refers to a case in which the parameter of the user character 22 is larger than the parameter of the opponent character 23, and a case with the value of “Δp” being a negative value refers to a case in which the parameter of the user character 22 is smaller than the parameter of the opponent character 23.

The control unit 11 obtains display manner information correlated to the result of comparison (Δp) between the parameter of the user character 22 and that of the opponent character 23, with reference to the correlation information shown in FIG. 20. Then, the control unit 11 sets the display manner for the area image to the display manner indicated by the display manner information.

In the manner described above, the user can know the result of comparison between the parameter of the user character 22 and the parameter of the opponent character 23 included in the area 50 designated through the designation operation (the operation of drawing the trace 52), with reference to the display manner for the area image (the trace 52). Therefore, it is possible to know at a glance whether the opponent character 23 is stronger or weaker than the user character 22 before fighting with the opponent character 23.

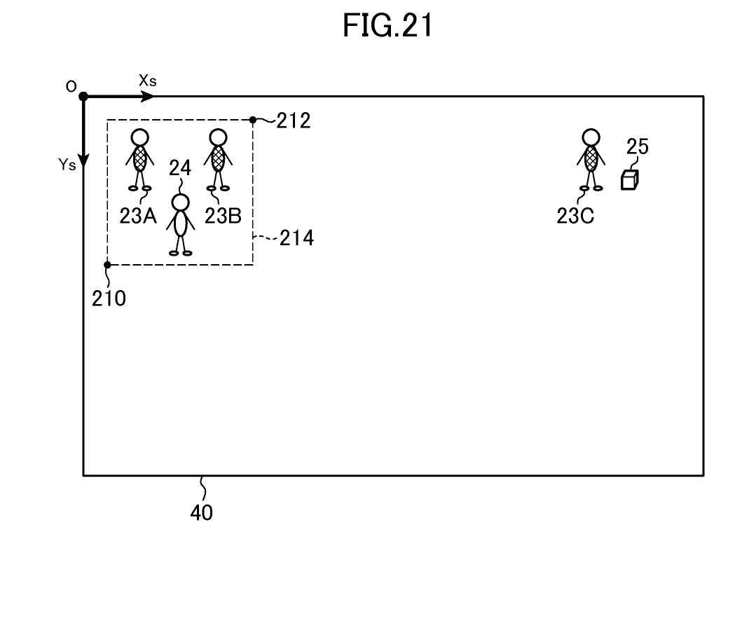

(3) The designation operation is not limited to the operation of drawing the trace 52, and may be other operations. For example, the designation operation may be an operation of designating two positions 210, 212 on the touch panel 17, as shown in FIG. 21, for example. In this case, a rectangular area 214 having the straight line connecting the two positions 210, 212 as a diagonal line corresponds to the “area in the screen 40 designated through the designation operation”. Further, in this case, a period of time needed to designate the two positions 210, 212 corresponds to the “period of time needed for the designation operation (the operation time)”. For example, in the case where the position 210 is designated first and the position 212 is designated thereafter, the period of time after designation of the position 210 until designation of the position 212 corresponds to the “period of time needed for the designation operation (the operation time)”.

(4) The user character 22 may not be placed in the virtual space 20. In this case, the virtual camera 30 alone moves according to an operation by the user.

(5) Relative positional relationship between the user character 22 and the virtual camera 30 may vary. For example, the virtual camera 30 may be automatically set at the optimum position in accordance with the positional relationship between the user character 22 and another object (for example, the opponent character 23). In such a case, the user character 22 alone may move in accordance with an operation by the user.

(6) The game device 10 may have a pointing device other than the touch panel 17. For example, the game device 10 may have a mouse. Further, the game device 10 may have a pointing device, such as a remote controller of Wii (registered trademark) manufactured by Nintendo Co., Ltd. Alternatively, the game device 10 may have a pointing device, such as a controller of KINECT (registered trademark) manufactured by Microsoft Corporation. In this case, the position of a predetermined portion (for example, the right hand) of a user is considered as a position designated by the user.

(7) A game executed in the game device 10 is not limited to the above described game. The present invention is applicable to a game in which an object operated by a user and/or the virtual camera 30 move/moves according to an operation by the user. Further, the present invention is applicable to an image processing device other than the game device 10. The present invention is applicable to an image processing device for displaying on display means a screen where an object operated by the user and/or the virtual camera 30 move/moves according to an operation by the user.

The invention claimed is:

1. An image processing device for displaying on display means a screen showing a virtual space, where at least one object is placed, viewed from a virtual camera, the image processing device comprising:
operation receiving means for receiving a designation operation for designating a partial area in the screen;
operation time information obtaining means for obtaining information on a period of time needed for the designation operation; and
movement control means for moving at least one of the virtual camera and an operation target object so as to approach a focus area in the virtual space displayed in the partial area,
wherein the movement control means comprises:
movement target position determination means for determining a movement target position for the at least one of the virtual camera and the operation target object in the case of moving the at least one of the virtual camera and the operation target object so as to approach the focus area, based on a position in the virtual space, of the designated partial area and a size of the designated partial area,
movement manner determination means for determining a movement manner in the case of moving the at least one of the virtual camera and the operation target object toward the movement target position, based on the period of time needed for the designation operation, and
means for moving the at least one of the virtual camera and the operation target object toward the movement target position in the movement manner determined by the movement manner determination means.

2. The image processing device according to claim 1, wherein
the movement manner determination means determines a moving speed in the case of moving the at least one of the virtual camera and the operation target object toward the movement target position, based on the period of time needed for the designation operation.

3. The image processing device according to claim 1, wherein
the movement manner determination means comprises means for obtaining an operation speed of the designation operation, based on the period of time needed for the designation operation, and determines the movement manner in the case of moving the at least one of the virtual camera and the operation target object toward the movement target position, based on the operation speed of the designation operation.

4. The image processing device according to claim 1, further comprising:
means for displaying an image showing the partial area in the screen; and
means for changing a display manner for the image showing the partial image, based on a result of comparison between a parameter of the operation target object and a parameter of an object included in the partial area.

5. A method for controlling an image processing device for displaying on a display a screen showing a virtual space, where at least one object is placed, viewed from a virtual camera, the method comprising:
receiving a designation operation for designating a partial area in the screen;
obtaining information on a period of time needed for the designation operation; and
moving at least one of the virtual camera and an operation target object so as to approach a focus area in the virtual space displayed in the partial area,
wherein the moving comprises:
determining a movement target position for the at least one of the virtual camera and the operation target object in the case of moving the at least one of the virtual camera and the operation target object toward the focus area, based on a position in the virtual space, of the designated partial area and a size of the designated partial area,
determining a movement manner in the case of the at least one of moving the virtual camera and the operation target object toward the movement target position, based on the period of time needed for the designation operation, and
moving the at least one of the virtual camera and the operation target object toward the movement target position in the determined movement manner.

6. A non-transitory computer readable information storage medium storing a program for causing a computer to function as an image processing device for displaying on a display a screen showing a virtual space, where at least one object is placed, viewed from a virtual camera, the program for causing the computer to:
receive a designation operation for designating a partial area in the screen;
obtain information on a period of time needed for the designation operation; and
move at least one of the virtual camera and an operation target object so as to approach a focus area in the virtual space displayed in the partial area,
wherein the program causes the computer to:
determine a movement target position for the at least one of the virtual camera and the operation target object in the case of moving the at least one of the virtual camera and the operation target object so as to approach the focus area, based on a position in the virtual space, of the designated partial area and a size of the designated partial area,
determine a movement manner in the case of moving the at least one of the virtual camera and the operation target object toward the movement target position, based on the period of time needed for the designation operation, and
move the at least one of the virtual camera and the operation target object toward the movement target position in the determined movement manner.

7-9. (canceled)
